(19) United States
(12) Patent Application Publication
(10) Pub. No.: US 2007/0244754 A1
(43) Pub. Date: Oct. 18, 2007

(54) Research-based design

(75) Inventors: Karen Elaine Payne, Brookville, OH (US); Walter Reynolds, Dayton, OH (US); Matilda Jackson, Dayton, OH (US)

Correspondence Address: LEE & HAYES, PLLC, 421 W. RIVERSIDE AVE., SUITE 500, SPOKANE, WA, 99201, US

(73) Assignee: BellSouth Intellectual Property Corporation, Wilmington, DE (US)

(21) Appl. No.: 11/493,840

(22) Filed: Jul. 26, 2006

Related U.S. Application Data
(60) Provisional application No. 60/702,791, filed on Jul. 26, 2005.

(51) Int. Cl. G06Q 30/00; G07G 1/00

(52) U.S. Cl. 705/14; 705/10

(57) ABSTRACT

Research-based design is described. In an embodiment, research data can be assessed to produce a list of objective factors that produce an elevated consumer response to designs, and a design scoring methodology can be developed based on the design research data and the objective factors. The objective factors can be applied to create a new design, and the new design can be scored utilizing the design scoring methodology to evaluate whether the new design would achieve the elevated consumer response.

### RELATED APPLICATIONS

This application claims priority under 35 U.S.C. §119(e) to commonly owned U.S. Provisional Application Ser. No. 60/702,791, filed Jul. 26, 2005, the disclosure of which is incorporated by reference herein.

### BACKGROUND

Designs for the layout and presentation of products and graphic content materials are typically created by designers following careful consideration of the business practices, specified preferences, and existing products and services of a client requesting a specific design. Frequently, much of the creation of a design is fashioned according to a designer's personal artistic style and overall experience in selecting successful layouts and content. Design is oftentimes subjective, with design creation and promotion primarily supported by subjective opinions regarding the best material or most qualified content for a particular advertisement.

Once a design is created according to client preferences and designer abilities, the design is placed in circulation where consumer response can be assessed and evaluated. If consumer response is satisfactory, oftentimes little or no changes are made and the design continues in circulation. However, if consumer response is poor, changes and improvements to the design are frequently completed in an attempt to garner higher consumer response to the design promotion. This design-and-test method is time consuming and inefficient, and as a result, lacks cost effective qualities for clients.

### SUMMARY

This summary is provided to introduce simplified features and concepts of research-based design which is further described below in the Detailed Description. This summary is not intended to identify essential features of the claimed subject matter, nor is it intended for use in determining the scope of the claimed subject matter.

In an embodiment of research-based design, research data relevant to the type of design to be created can be assessed to produce a list of objective factors that produce an elevated consumer response to the design, and a scoring methodology can be developed based on the research data and the objective factors. The objective factors can be applied to create a new design, which can then be scored utilizing the scoring methodology to evaluate whether the new design would achieve an elevated consumer response.

In another embodiment of research-based design, an existing design can be evaluated and a score generated utilizing a scoring methodology based on research data and objective factors found to produce an elevated consumer response. Furthermore, the content and design of an additional comparable design can be scored based on the scoring methodology to generate an additional score. The differences in the scores of the design and the additional design can be compared, where the compared differences can be used to support subsequent improvements to the design. Improvements to the design are also based on the received score and demonstrated weaknesses, and can be made to elevate consumer response to the design.

In another embodiment of research-based design, a research-based design system includes research data and objective factors found to produce an elevated consumer response, and includes a design evaluation application. The design evaluation application can be implemented to: Score the design to generate a score utilizing a scoring methodology based on the research data and objective factors; score an additional design to generate an additional score based on the scoring methodology; and compare differences in the scores of the design and the additional design to support a basis for improvements. The design evaluation application can also be implemented to generate an improved design based on the research data, based on the compared differences in the scores of the design and the additional design, and based on the absence of content in the design that would produce the elevated consumer response.

### BRIEF DESCRIPTION OF THE DRAWINGS

The same numbers are used throughout the drawings to reference like features and components:

FIG. 1 illustrates the creation of an advertisement design as an example of research-based design.

FIG. 2 illustrates an example of an embodiment of research-based design.

FIG. 3 continues the example of the embodiment of research-based design of FIG. 2.

FIG. 4 illustrates various components of an exemplary computing-based device in which embodiments of research-based design can be implemented.

FIG. 5 illustrates exemplary method(s) for research-based design.

### DETAILED DESCRIPTION

Research-based design is described in which embodiments provide for the creation of designs based on relevant industry research data, objective factors generated from the data found to generate high consumer responses, and a scoring methodology where designs are evaluated and scored based on the generated objective factors. Research-based design also provides for the evaluation of one design compared to another design based on assessed scores and market performance. The evaluation and scoring process of research-based design provides designers with objective support for creative design choices and an enhanced ability to demonstrate the value and potential success of designs to clients. In turn, research-based design improves efficiency and cost effectiveness for clients while providing objective indications of a design's impact on consumer interest and response.

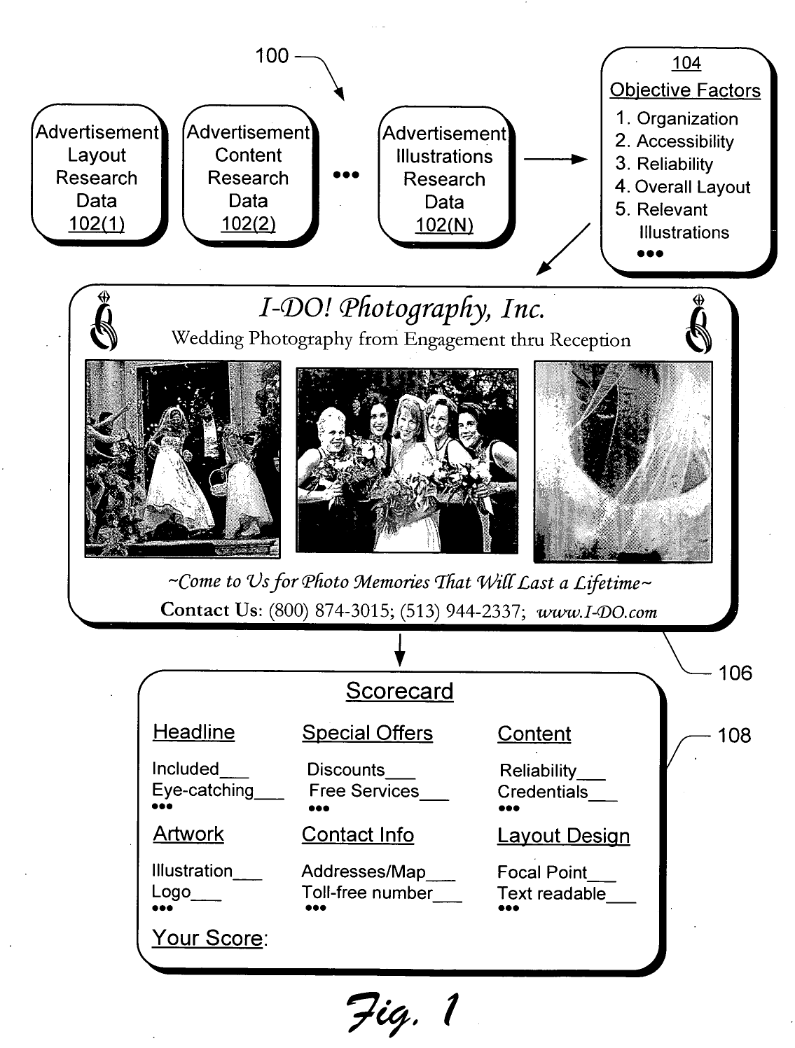

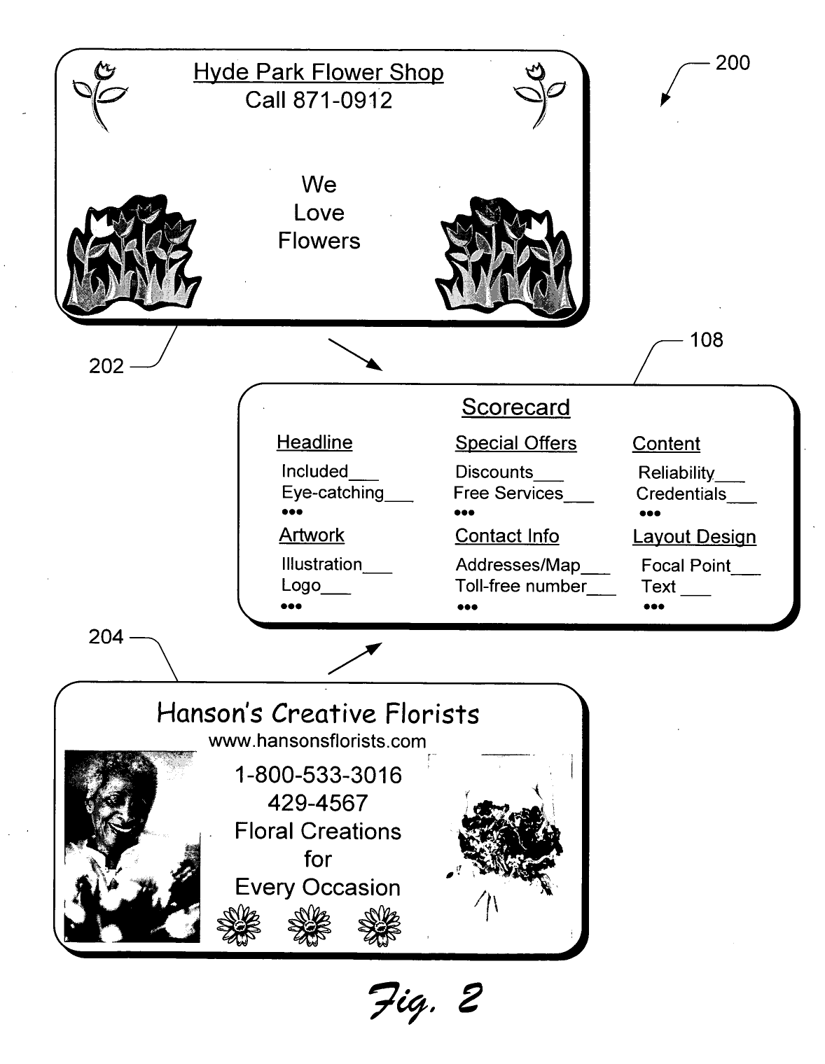

Research-based design techniques as described herein can be utilized to create designs for the layout and presentation of a number of various products and graphic content materials. Examples of applications of research-based design include designs created for advertisements, books, textbooks, products, computer-related products, toys, or the like. For ease of explanation, this application describes research-based design as applied to the design of advertisements. The following description for the design of advertisements, with corresponding FIGS. 1-5, serve as an example of the utilization of research-based design. This description does not limit research-based design to this advertisement design embodiment.

The research-based design of advertisements provides for the creation of advertisement designs based on industry research data and objective factors generated from the data found to generate high consumer responses. The scoring methodology utilized in research-based design provides for the evaluation of advertisement designs that are scored based on the generated objective factors. The creation of advertisement designs utilizing research-based design also provides for the evaluation of one advertisement design compared to another advertisement design based on the received scores and general public reception. Research-based design as applied to the design of advertisements provides designers with objective support for design choices as well as for a described impact the design may have on consumer response.

Research-based design of advertisements also provides an ability to tailor the content and design of an advertisement to a particular client advertiser by analyzing and applying advertising-industry research data relevant to the client's specific product or service to the design. The relevant research data provides an advertising designer with objective insights into the key areas that drive consumer response to a product or service, enabling the design of advertisements that produce an effective impact on consumer interest and response. In this manner advertisers are able to maximize returns achieved on advertising investments.

Research-based design of advertisements also provides for demonstrations of advertisement weaknesses through objective scoring with the scoring methodology. A comparison of the score of an advertisement to the score of either a competing advertisement or a newly created advertisement promoting the same product or service provides an assessment of the weaknesses in the advertisement and allows for new design suggestions for producing greater consumer responses.

Research-based design of advertisements also provides for a relative prediction of an advertisement's success when the advertisement is evaluated using the objective scoring methodology. The objective scoring methodology provides that advertising designers can project a likelihood of advertisement success based on information acquired from advertising-industry research data. Knowledge gained from the advertising-industry research data also provides advertising designers objective support for design decisions instead of the usual subjective opinions regarding design quality and potential advertisement success.

While features and concepts of the described systems and methods for research-based design can be implemented in any number of different environments, systems, and computing-based systems, embodiments of research-based design are described in the context of the following exemplary systems and environments.

FIG. 1 illustrates an advertisement design example 100 of research-based design. This advertisement design example 100 includes advertisement research data 102(1-N), (also referred to herein as just “102”), objective factors 104, an advertisement 106, and a scorecard 108. The advertisement 106 is created based on advertisement research data 102 and objective factors 104 that provide for the most appropriate location, market, and position for public circulation of the advertisement. The advertisement 106 is subsequently scored utilizing a scorecard 108 that contains several factors found to influence consumer interest and response to advertisements. Advertisement 106 serves only as an example of a newly created advertisement, may be an advertisement for any product or service, and can include any number of illustrations, graphics, images, numbers, words, font types, displays, and/or any other type of advertising-related information.

In this example, advertisement 106 for “I-DO! Photography, Inc.” is an example of a newly created advertisement based on various advertisement research data 102 and objective factors 104 utilizing research-based design. The advertisement research data 102 relied upon for the creation of the “I-DO! Photography, Inc.” advertisement 106 can be advertisement research data that is relevant to weddings, and in particular to wedding photography, as offered in advertisement 106.

The scorecard 108 is but one possible one mechanism for the implementation of the developed scoring methodology in an embodiment of research-based design. Scoring the advertisement 106 with the scorecard 108 provides for an evaluation of the advertisement to determine elements or factors likely to increase consumer response. The scorecard 108 includes a list of factors, produced from the analysis of advertisement-industry research, that are found to likely generate consumer interest and response to an advertisement. The list of factors in the scorecard 108 not only focus on the presence of an element in the advertisement, but also focus on the presentation of that particular element, such as its size, color, font, and prominence relative to other elements in the advertisement. The objective factors also address additional features of an advertisement, such as its location in a medium as circulated and the overall layout of the advertisement. In this example, the factors listed on the scorecard 108 include, but are not limited to, headlines, artwork and illustrations, layout design, text, logo visibility and quality, overall advertisement content, special offers, differentiating services that competitors do not offer, credentials, and varied contact information, such as website addresses, toll-free numbers, maps, and local numbers.

The advertisement 106 can be evaluated utilizing the scoring methodology, and a score for the advertisement resulting from the scoring methodology can be based on the scorecard 108 factors. If the advertisement 106 is a newly created advertisement based on advertising-industry research relevant to the product or service advertised, the resultant score would presumably be high, as factors and elements expected to induce an elevated consumer response would have been considered in the original design of the advertisement 106. The score of this new advertisement would reflect a design which highlighted factors expected to attract consumers to the particular product or service advertised.

An objective of an advertising strategy utilizing research-based design is to appeal to the analytical and emotional connections advertisers have to advertising. The advertising industry is a competitive business, making it important for advertising designers to prove design value to clients while also innovating and improving work product to maximize client returns on advertising investments. An additional goal of this advertising strategy utilizing research-based design is to involve the advertising client in the creation of an advertisement to promote brand alignment and to engage the client in the creative design process.

The development of a program to execute this overall advertising strategy utilizing research-based design can be implemented using at least the following processes: (1) Analyze; (2) Develop; (3) Prove; and (4) Deploy. Explanation of these processes now follows in succession.

The “analyze” process of the program involves the analysis of advertisement research data 102 gathered from multiple sources and various research studies conducted by advertising industry leaders. One goal of this analysis is to identify key drivers that impact consumer response to advertising and to determine the best practices, methods, and consumer-related bases for advertisement design. This analysis of advertisement research data 102 has resulted in the identification of certain impact areas that may influence the ability of an advertisement to drive consumer response. Examples of these impact areas may include the ability of an advertisement to attract attention, to create interest, to answer a need, and to stimulate action. Additional analyses of the advertisement research data 102 can identify key objective factors 104 that further define these impact areas and provide specific elements influencing consumer response to advertisements in each of the areas.

The “develop” process for an advertising strategy using research-based design involves the creation of supporting collateral and defined operational processes for new and existing business pitches. A goal in the creation of the operational processes is to engage advertisers throughout the creative process of an advertisement. The development of the operational creative process can include, for example: (1) Creative analysis with the client, including profiling a client's business, marketing strategy, and creative preferences; (2) Analysis of competitors, including investigating Web sites to identify competitive differentiators, and assessing the color and size of competitive advertisements; (3) Development of a strategy through the creation of advertisement templates and a research-based design, in addition to the design of brand-consistent advertisement concepts; and (4) Presentation of the completed advertisement design to the client with a review of the research data used to create the design and an explanation for choices made in the design of the advertisement.

The “prove” process in an advertising strategy provides for a determination of the impact and value provided to an advertiser by the research-based design of the advertisement and the selected channel or location for its circulation. This determination can be accomplished through tracking of consumer response results, proactive testing, and in-depth analysis of the advertisement and its finished design. Testing and analysis can be conducted via split-run advertising studies, online panels, questionnaires, and organized focus groups, to name but a few possible examples.

The “deploy” process of an advertising strategy provides for the introduction of the strategy and method to employees who regularly engage advertising clients. A goal in the deployment of an advertisement is to formulate a strategy utilizing research-based design as a consistent, integral part of the advertising go-to-market presentation. The strategy can involve updating the client presentations to include research-based design.

Deployment and execution of research-based design can provide advertising designers and representatives with due diligence prior to the circulation of an advertisement. Research-based design enables advertising designers to identify opportunities in existing advertising, ensure brand alignment, and enhance consumers' responses to a client's advertising.

As stated previously, analysis of advertisement research data 102 can result in the identification of the impact areas described herein. These impact areas may influence the ability of an advertisement to drive consumer response, such as the ability of an advertisement to attract attention, to create interest, to answer a need, and to stimulate action. Additional analyses of the advertisement research data 102 can produce a number of objective factors 104 that further define these impact areas and provide specific, detailed elements that affect consumer response to advertisements. Objective factors 104 are identified as key drivers of advertisement success that produce a high impact on consumer response to advertisements.

The ability of an advertisement to attract attention relates to its ability to engage potential consumer interest by piquing curiosity long enough to initiate investigation of the advertisement. The objective factors 104 identified with an advertisement's ability to attract attention include, but are not limited to, the appearance of the advertisement headline and its prominent display; photos or illustrations that attract and engage potential consumers; the display of professional-quality logos in an eye-catching manner; and an overall layout design containing text that is easy to read and possesses key focal points attracting attention.

The ability of an advertisement to create interest and impact consumer response carries a potential consumer's initial attracted attention to an advertisement one step further. An advertisement creates interest in a potential consumer through the use of tactics intended to maintain the initial attraction to the advertisement while also prompting further inquiry and examination into the advertisement. Objective factors 104 that are associated with the ability of an advertisement to create interest include, but are not limited to, headlines containing differentiating selling points; artwork in any form displaying the solution to a problem accomplished by the product or service in the advertisement; and special offers such as coupons or discounts highlighted with callout boxes, buttons, starbursts, and the like.

The ability of an advertisement to impact consumer response by answering consumer needs can be dependent upon the content of the advertisement. When determining whether an advertisement actually answers the needs of potential consumers, the manner in which the content of the advertisement is displayed and the nature of the content presented can be evaluated. Objective factors 104 associated with the ability of an advertisement to answer consumer needs include but are not limited to, content that demonstrates reliability, such as years of service, company size, and guarantees for service and products; honest credentials, such as licensure, bonded status, certifications, and member associations; accessibility, including hours of operation, emergency services, and weekend or evening availability; and payment options, including credit cards payments or financing and payment plans.

The ability of an advertisement to impact consumer response by stimulating action relates to the presence of contact information and a “call to action” in the advertisement. Potential consumers are presumed to be busy, requiring quick and easy access to information in an advertisement. Many consumers also respond more readily to advertisements that contain encouraging statements and reasons for choosing the advertised product or service over another. Objective factors 104 in an advertisement that may stimulate action by consumers include, but are not limited to, visible, easy to read contact information, including website addresses, local phone numbers, toll free numbers, and addresses with maps. Additional objective factors 104 for stimulating consumer action are actual “calls to action” in the advertisement, including “Call now!” or “Visit us today!” followed by reasons for consumers to call, such as “Call for your free consultation,” or “Ask about our money-back guarantee,” in addition to numerous other motivations for stimulating response by consumers to particular advertisements.

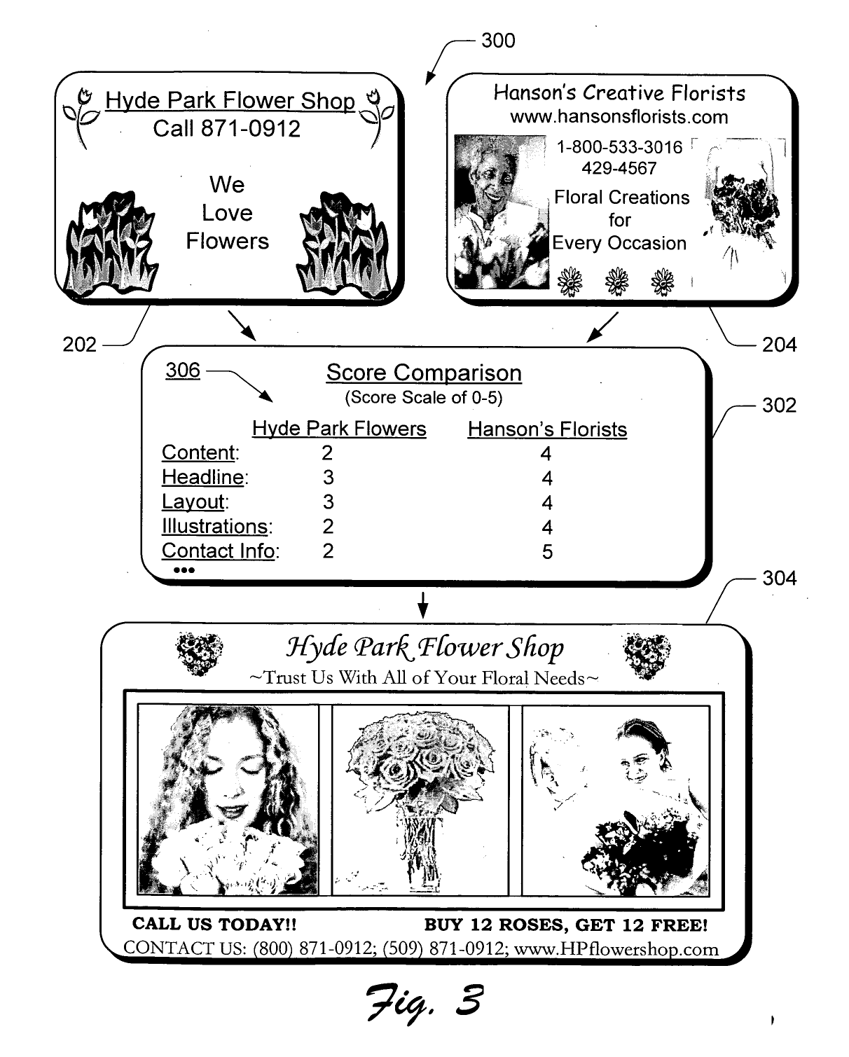

FIG. 2 illustrates an example 200 of a comparison of advertisement designs in which embodiments of research-based design can be implemented. The example 200 includes an advertisement 202 which is currently in use and in circulation by a client, an additional advertisement 204 to which the advertisement 202 may be compared, and the scorecard 108 for implementing the scoring methodology for the evaluation of advertisements. Research-based comparison of advertisement designs provides for the comparison of the advertisement 202 and the additional advertisement 204 using the scoring methodology to evaluate advertisement design and content. The advertisements can be assessed for the existence of objective factors found to produce elevated consumer interest and response.

The advertisement 202 is an advertisement which is merely an example that can be used for the comparison of advertisement designs and which is currently in use for the promotion of a service or product, such as flowers for the “Hyde Park Flower Shop.” Any product or service presenting any number of different advertisement designs may be used as the advertisement 202. In this example 200, the advertisement 202 endorsing the “Hyde Park Flower Shop” was created without utilization of the research-based design method.

The additional advertisement 204 can either be a competing advertisement to the advertisement 202, or a newly created advertisement utilizing research-based design. Whether the additional advertisement 204 is that of a competitor or is newly created, use of an advertisement endorsing the same service or product as that endorsed in the advertisement 202 can be effective in the comparison of advertisement designs. In this example 200, the additional advertisement 204 is the advertisement of a competitor, “Hanson's Creative Florists,” which is also a florist promoting the sale of flowers.

The scorecard 108 can be used to implement the scoring methodology and is the same scorecard 108, containing the factors based on advertising-industry research as described in FIG. 1. The scorecard 108 provides for the comparison of advertisement designs through the production of scores for the advertisement 202 and the additional advertisement 204. The scores can then be evaluated for each of the advertisements.

In this example 200, the “Hyde Park Flower Shop” advertisement 202 is scored utilizing the scorecard 108, and the competing advertisement 204 for “Hanson's Creative Florists” is also scored utilizing the scorecard 108. The “Hyde Park Flower Shop” advertisement 202 is a very basic, plain advertisement with poor illustrations, minimal content, and very little information that would be of interest to potential consumers. The competing “Hanson's Creative Florists” advertisement 204 contains several noticeable features, including eye-catching pictures, a variety of available contact information, and an overall pleasing layout and design. An evaluation of the “Hyde Park Flower Shop” advertisement 202 and the “Hanson's Creative Florists” advertisement 204, and the strengths and weaknesses of both, can be presented utilizing the scorecard 108 to generate a score for each advertisement.

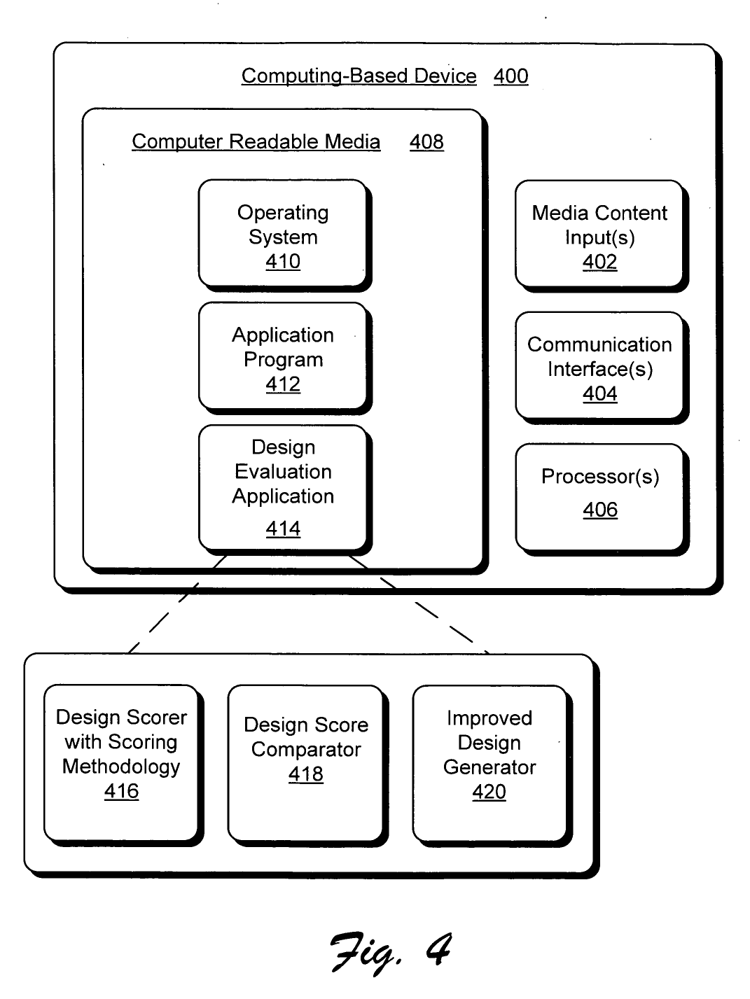

FIG. 3 illustrates an example 300 in which embodiments of research-based design can be implemented, and continues the example 200 for the comparison of advertisement designs as described with reference to FIG. 2. The example 300 includes the advertisement 202 and the additional advertisement 204, a score comparison chart 302, a new advertisement design 304, and an actual score comparison 306. The new advertisement design 304 is an example of an advertisement that is created after evaluating the score comparison 306 between the advertisement 202 and the additional advertisement 204. In this example, the new advertisement design 304 for the “Hyde Park Flower Shop” serves as an illustration of a new advertisement created following the score comparison 306 and evaluation. As stated earlier, the advertisement 202 can be an advertisement for a variety of products or services, and therefore the new, improved advertisement design 304 can also be an advertisement for a variety of products or services.

In one embodiment of example 300, the score received by the advertisement 202 is compared to the score of the competing additional advertisement 204. The scores are displayed together in the score comparison chart 302 to provide an effective visualization of the strengths and weaknesses of each advertisement as compared to the other. The score comparison chart 302 displays a list of at least some of the factors evaluated in the advertisements and scored utilizing the scorecard 108. In this example 300, the objective factors listed are the content, headline, layout, illustrations, and contact information of the advertisements. This list of objective factors in the score comparison chart 302 is only a shortened example of the many possible objective factors that can be used when scoring and comparing advertisements, and does not limit the possible objective factors that may be used for scoring and comparing advertisements.

An advertising designer offering to improve the design of an existing advertisement 202 may utilize example 300 for scoring and comparing two or more different advertisements to reveal the strengths and weaknesses of these different advertisements. The advertisement 202 and the competing advertisement 204 provide examples of two such different advertisements. Following the comparison, the advertising designer can use the information gathered from the scoring and advertisement comparison to provide objective analyses for selected design improvements. This approach is particularly advantageous when the advertisement 202 and the additional advertisement 204 compete closely with one another, and when even minor changes to an advertisement design could produce significant increases in consumer response to one advertisement over the other.

In this example 300, the score received by the “Hyde Park Flower Shop” advertisement 202 is compared to the score received by the competing advertisement 204 for “Hanson's Creative Florists.” Both scores are displayed in the score comparison chart 302. As evidenced by the scores, the “Hyde Park Flower Shop” advertisement 202 performed poorly and received low scores due to the substandard layout and minimal amount of helpful content. The competing “Hanson's Creative Florists” advertisement 204 received higher scores than the “Hyde Park Flower Shop” advertisement 202, due to several noticeable features in the advertisement, including eye-catching pictures, a variety of available contact information, and overall pleasing layout and design. An evaluation of the overall performance of the “Hyde Park Flower Shop” advertisement 202 and the “Hanson's Creative Florists” advertisement 204, and a comparison of the scores, can be conducted to determine weaknesses in the advertisement 202 and whether changes and improvements to the design should be made.

Following a score comparison and evaluation, a new advertisement design 304 can be constructed for the advertisement 202. A range of differing new advertisement designs (such as advertisement design 304) may be produced utilizing the same information received from the score comparison 306, because the particular artistic design of advertisements is advertising designer-dependent. Although the actual artistic appearance of the various new advertisement designs may differ, the existence of specific design content and the particular arrangement of that content would reflect knowledge gained from the score comparison 306 and the objective factors of the scorecard 108 found to increase consumer response.

In this example 300, the new advertisement design 304 is created for the “Hyde Park Flower Shop” advertisement 202. The score comparison chart 302 and further analysis of the limitations and weaknesses in the “Hyde Park Flower Shop” advertisement 202 can aid in the production of a new design containing content that is based upon factors likely to increase consumer response to the advertisement. The new advertisement design 304 for the “Hyde Park Flower Shop” includes an enhanced overall layout with improved photos, contact information, and content useful to potential consumers. The new advertisement design 304 demonstrates overall improvements that can be made to existing advertisements 202 following the comparison of advertisement designs.

In another embodiment of example 300 involving the comparison of advertisement designs, the score of the client's advertisement 202 can be compared to the score of the additional advertisement 204 that was originally created utilizing research-based advertising design. As stated previously, the additional advertisement 204 may promote the same product or service as the advertisement 202. The newly created additional advertisement 204 may possess objective research support for its design, thereby demonstrating to advertisers the numerous possibilities for advertisement improvements. Evaluations of the scores of the advertisements using the score comparison chart 302 demonstrates clear differences in the designs of the advertisements and reveals deficiencies in advertisement 202 content that, if improved, could increase consumer response and interest.

Advertising designers can utilize the scoring methodology of examples 200 and 300 for advertisements that are already in existence and in circulation. The designers can score these existing advertisements to demonstrate to clients the limitations and weaknesses of their advertisements, while providing insight into how to improve the advertisements. The advertisement score comparison 306 of example 300 supplements this advantage by providing clients with a revealing display how other advertisements perform in comparison to their own. As a result, the scoring methodology provides advertising designers with objective support for their improved advertisement designs, while also instilling greater confidence in clients that their advertising decisions are sound. This ability to objectively support designing decisions can act as a differentiator for advertising designers in a competitive advertising industry, where often support for advertising design is based on subjective opinions. The scoring methodology and comparison of advertisement scores provides an advantage to advertising designers when acquiring new clientele, as well as providing better quality service to existing clients.

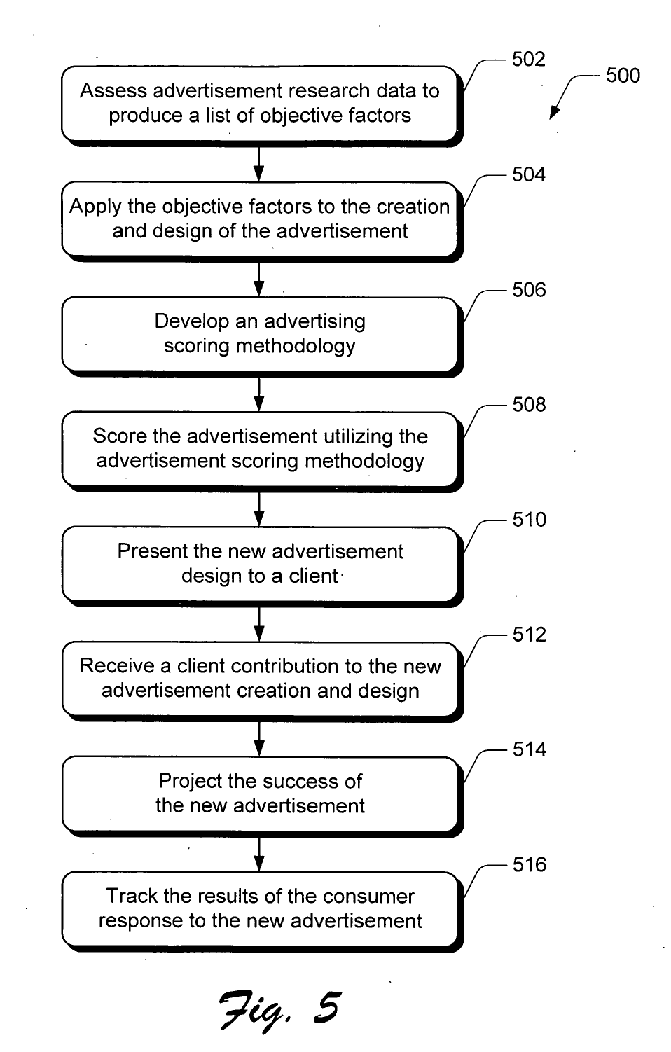

FIG. 4 illustrates various components of an exemplary computing-based device 400 which can be implemented as any form of a computing or electronic device, and in which embodiments of research-based design can be implemented. Computing-based device 400 includes one or more media content inputs 402 which may include Internet Protocol (IP) inputs over which streams of media content are received via an IP-based network. Device 400 further includes communication interface(s) 404 which can be implemented as any one or more of a serial and/or parallel interface, a wireless interface, any type of network interface, a modem, and as any other type of communication interface.

A network communication interface(s) 404 provides a connection between the computing-based device 400 and a communication network by which other electronic and computing devices can communicate data with device 400. Similarly, a serial and/or parallel interface provides for data communication directly between computing-based device 400 and other electronic or computing devices. A modem facilitates computing-based device 400 communication by the communication interface(s) 404 with other electronic and computing devices via a conventional telephone line, a DSL connection, cable, and/or other type of connection.

Computing-based device 400 also includes one or more processors 406 (e.g., any of microprocessors, controllers, and the like) which process various computer executable instructions to control the operation of device 400, to communicate with other electronic and computing devices, and to implement embodiments of research-based design. Computing-based device 400 can be implemented with computer readable media 408, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 408 provides data storage mechanisms to store various information and/or data such as software applications and any other types of information and data related to operational aspects of computing-based device 400. For example, an operating system 410 and/or other application programs 412 can be maintained as software applications with the computer readable media 408 and executed on processor(s) 406 to implement embodiments of research-based design.

A design evaluation application 414 can be maintained as one or more software applications with the computer-readable media 408. These software applications can include a research-based design system containing research data and objective factors that are found to produce an elevated consumer response to designs. The design evaluation application 414 can be implemented to include a design scorer with scoring methodology 416, a design score comparator 418, and an improved design generator 420.

For example, the design evaluation application 414 can be implemented to process a score for a design by the design scorer with scoring methodology 416, to compare the scores of two designs with the design score comparator 418, and to create an improved design with the improved design generator 420. The design scorer with scoring methodology 416 can be implemented to determine the score of a design by utilizing a scoring methodology based on research data and objective factors found to produce an elevated consumer response. The design scorer with scoring methodology 416 can be implemented to then determine the score of an additional design utilizing the same research-based scoring methodology. Subsequently, the design score comparator 418 can compare the differences in the scores of the design and the additional design to determine future design improvements. Finally, the improved design generator 420 can be implemented to generate an improved design based on the research data, the compared differences in the scores of the design and the additional design, and the absence of content in the design that would produce the elevated consumer response.

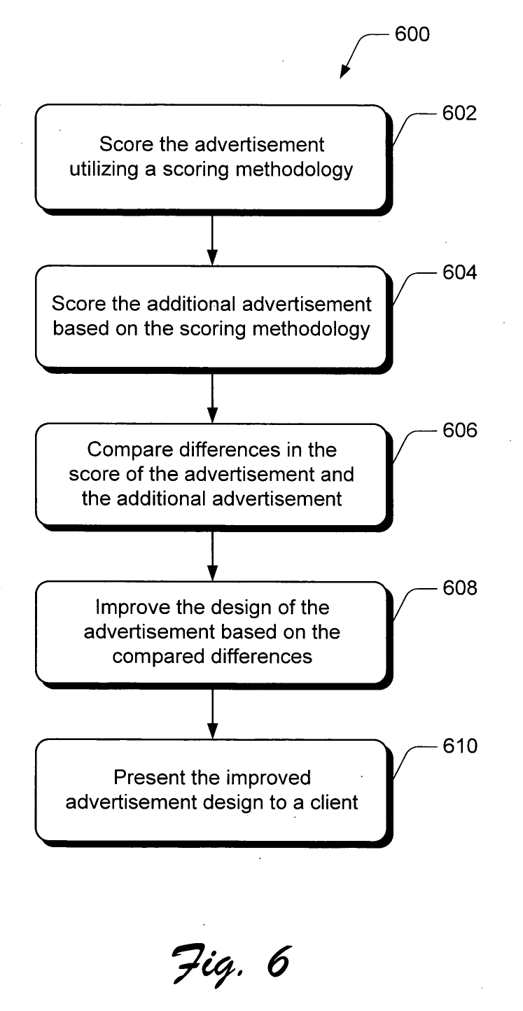

Methods for research-based design, such as exemplary methods 500 and 600 described with reference to respective FIGS. 5 and 6, may be described in the general context of computer executable instructions. Generally, computer executable instructions can include applications, routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for research-based design as applied to the creation and design of an advertisement. The order in which the method is described is not intended to be construed as a limitation, and any number of the described method blocks can be combined in any order to implement the method, or an alternate method.

At block 502, advertisement research data is assessed to produce a list of objective factors. For example, the advertisement layout, content, and illustrations research data 102, to name only a few of the types of advertisement research data 102 evaluated, is analyzed to identify key drivers that impact consumer response to a particular product or service. The advertisement research data 102 assessed in each case is that research data relevant to the product or service to be promoted in the advertisement 106. These key drivers are subsequently listed as the objective factors 104 to be considered when creating and designing a new advertisement 106.

At block 504, the objective factors are applied to create and design a new advertisement. For example, objective factors 104 such as the overall layout and organization of the advertisement design, the accessibility of information in the advertisement, the reliability of information in the advertisement, and relevant illustrations are just a few objective factors considered when designing and creating a new advertisement 106. Because the objective factors 104 are produced from advertising research data 102, the creation and design of the advertisement 106 has reliable support and an objective explanation for the chosen design, rather than a subjective opinion concerning design quality.

At block 506, an advertisement scoring methodology is developed based on advertisement research data and objective factors. For example, the scoring methodology and scorecard 108 used to implement the scoring methodology are developed following the assessment of numerous advertising-industry research studies and the application of the key learning and design principles from broader advertising research to advertising design. Following an analysis of the advertisement research data 102 and an identification of several key factors that impact advertisement success, a scoring system utilizing the scorecard 108 can be developed. The scorecard 108 contains distinct factors for an advertisement to drive a high consumer response. The scorecard 108 provides an objective summary of measurable scoring results of the new advertisement and indicates areas where the new advertisement lacks content that elevates consumer response.

At block 508, the new advertisement is scored utilizing the advertisement scoring methodology and the scorecard to evaluate whether the new advertisement design would achieve the elevated consumer response. For example, the scorecard 108 enables the evaluation of the advertisement 106 and an analysis concerning the existence and display of particular factors likely to increase consumer response to advertisements. The scorecard 108 and resultant score following an evaluation can be used to demonstrate to a client the existence of an advertisement design that could garner a high, or higher, consumer response.

At block 510, the new advertisement design and a score are presented to the client, where the score is indicative of the objective factors used as a basis for the advertisement design. In various embodiments, an advertising designer can create a new advertisement design for a client after analyzing and assessing advertisement research data 102 and objective factors 104 relevant to the client's specific product or service. Following advertisement creation, the advertising designer may present the new design to the client and support the overall content, layout, and design of the new advertisement with the objective data. This approach offers objective support and can aid the advertising designer in design promotions to clients.

At block 512, client contribution to the creation and design of the new advertisement is received. For example, following an initial assessment of advertisement research data 102 and objective factors 104 related to the service or product of the client endorsement, the client can work alongside the advertisement designer and contribute to the creation and design of the advertisement. This arrangement can enable advertising clients to see first-hand various criteria considered in an advertisement design, while providing designers a greater certainty of client stipulations and desires regarding the design, as well as acceptance of the finished design.

At block 514, success of the new advertisement is projected where the advertisement is a product advertisement or a service advertisement, and where the success of the new advertisement is based on analysis of the advertisement research data and the objective factors relevant to the product or the service. For example, the new advertisement can be a yellow pages advertisement and the advertisement research data analyzed can be yellow pages-industry advertisement research data. The success of the yellow pages advertisement can be projected where the yellow pages-industry research data establishes the most appropriate directory, heading, and page position for the yellow pages advertisement, as well as the high traffic areas of the yellow pages text and the demographic profiles of potential customers of the product or service of the yellow pages advertisement.

At block 516, the results of the elevated consumer response to the new advertisement are tracked by conducting split-run advertisement studies, administering questionnaires, conducting online panels, or organizing focus groups. For example, consumer response to the advertisement design based on advertising research data 102 and objective factors 104 can be evaluated and tracked by handing out questionnaires in various public places such as malls, train and bus stations, or parks. The questionnaires can subsequently be retrieved from participants who have both seen the advertisement and responded to the questionnaire. These results, in addition to any results retrieved from other tracking methods, such as online panels and focus groups, can be gathered together and tallied over a period of time to track the general consuming public response to the research-based design.

FIG. 6 illustrates an exemplary method 600 for research-based design and is described with reference to examples 200 and 300 and the comparison of advertisement designs shown respectively in FIGS. 2 and 3. The order in which the method is described is not intended to be construed as a limitation, and any number of the described method blocks can be combined in any order to implement the method, or an alternate method.

At block 602, the content and design of an advertisement is scored utilizing the scoring methodology. For example, a client owns an advertisement 202 that is already in circulation, but would like to more efficiently utilize advertising dollars and garner higher consumer responses by making improvements to the design of the advertisement 202. In addition, the client would like to assess the performance of the advertisement 202 compared to competitors. Evaluation of the quality of the advertisement 202 and the existence of factors found to increase consumer interest and response can be accomplished through scoring the advertisement with the scoring methodology and scorecard 108. The scorecard 108 provides an objective summary of measurable scoring results of the advertisement, such that the scorecard 108 indicates areas where the advertisement lacks content that elevates consumer response.

At block 604, the content and design of an additional advertisement is scored utilizing the scoring methodology. In various embodiments, the additional advertisement 204 can either be an advertisement originally created by research-based design, or an already existing, competing advertisement to the advertisement 202 of the client. An additional advertisement 204 that is originally created utilizing research-based design can be created for purposes of comparison with the client's advertisement 202 already in circulation. This type of additional advertisement 204 can be designed following the assessment of advertisement research data 202 and objective factors 204 relevant to the product or service of the advertisement 202, in order to create an advertisement that would provide beneficial results in advertisement design comparisons.

In FIGS. 2 and 3, the additional advertisement 204 example is a competitor to the advertisement 202. In this example 200, the client owns an advertisement 202 already in circulation and would like to improve the design and consumer response to the advertisement 202. Advertisement research 202 data and objective factors 204 relevant to the product or service the client is advertising are analyzed, and a new, additional advertisement 204 is created. In order to assess the quality and performance of the client's advertisement 202 compared to the advertisement 204 of the competitor, the competitor's advertisement 204 is also scored utilizing the scoring methodology and scorecard 108, as described above.

At block 606, the differences in the scores of the advertisement and the additional advertisement are compared and assessed. For example, the scores for the client's advertisement 202 and the competitor's additional advertisement 204 are compared and listed side by side in a score comparison chart 302. The resultant scores can provide a detailed analysis of the strengths and weaknesses of both advertisements. In example 300, the client's advertisement 202 for the “Hyde Park Flower Shop” scored much lower than the competitor's advertisement 204 for “Hanson's Creative Florists.” Both the owner of the “Hyde Park Flower Shop” advertisement 202 and any advertising designer working with the flower shop to improve the advertisement 202 can gain knowledge from the advertisement scoring and the score comparison with the competitor, “Hanson's Creative Florists.” The client and advertising designer may now have objective insights into ways to improve the design of the advertisement 202.

At block 608, the advertisement design is improved into a new advertisement design based on the score of the advertisement and the compared advertisement design differences. For example, the comparison of the scores of the client's advertisement 202 and the competitor's advertisement 204 can provide an objective analysis of the performance of the advertisement and an opportunity to improve an advertisement 202 design into one that is superior to a competitor's. In example 300, the client advertisement 202 example is improved to strengthen discovered weaknesses in the design and to add content and features known to increase consumer response. The improvements to the advertisement design are based on the score that the original “Hyde Park Flower Shop” advertisement 202 received and on the comparison of that score with the score of the competitor, “Hanson's Creative Florists.” The new advertisement 304 design for “Hyde Park Flower Shop” contains added useful information with overall improvements in the layout and presentation of the advertisement content. The improved advertisement 304 is an example of the quality of advertisement design that can result from awareness of at least some of the many objective factors that drive consumer response to advertisements.

At block 610, the improved advertisement design is presented to a client. The improved advertisement design 304 can be indicative of the objective factors used as a basis for changes to the advertisement design and, as stated above, an example of the quality of potential advertisement designs when research-based advertisement data and objective factors are considered in the process of designing an advertisement. Presentation of the new advertisement 304 design to the client, together with the scoring methodology and score comparison results, provides validated reasons and support for design changes to an advertisement.

Although embodiments of research-based design have been described in language specific to features and/or methods, it is to be understood that the subject of the appended claims is not necessarily limited to the specific features or methods described. Rather, the specific features and methods are disclosed as exemplary implementations of research-based design.

1. A research-based method for the creation of a design, the method comprising:
assessing research data to produce a list of objective factors that produce an elevated consumer response to a design;
applying the objective factors to create a new design;
developing a scoring methodology based on the research data and the objective factors; and
scoring the new design utilizing the scoring methodology to evaluate whether the new design would achieve the elevated consumer response.

2. A research-based method as recited in claim 1, further comprising presenting the new design and a score to a client, where the score is indicative of the objective factors used as a basis for the design.

3. A research-based method as recited in claim 1, further comprising tracking results of the elevated consumer response to the new design by conducting at least one of: split-run design studies; administering questionnaires; conducting online panels; and organizing focus groups.

4. A research-based method as recited in claim 1, wherein the design is the design of an advertisement.

5. A research-based method as recited in claim 1, further comprising projecting a success of the new design which is associated with at least one of a product or a service, and wherein the success of the new design is based on an analysis of the research data and the objective factors that are relevant to the product or the service.

6. A research-based method as recited in claim 5, wherein the new design is a yellow pages advertisement, and the research data is yellow pages-industry advertisement research data, and wherein the yellow pages-industry advertisement research data establishes the most appropriate directory, heading, and page position for the yellow pages advertisement, as well as the high traffic areas of the yellow pages text and the demographic profiles of potential customers of the product or service of the yellow pages advertisement.

7. A research-based method as recited in claim 1, wherein the design scoring methodology includes a scorecard that provides an objective summary of measurable scoring results of the new design and indicates areas where the new design lacks content that elevates consumer response.

8. A computer-readable medium containing computer-executable instructions for performing actions, comprising:
scoring the design of an advertisement to generate a score utilizing a scoring methodology based on advertisement research data and objective factors found to generate an elevated consumer response;
scoring the content and design of an additional advertisement based on the scoring methodology to generate an additional score;
comparing differences in the scores of the advertisement and the additional advertisement to support a basis for an improvement to the design of the advertisement; and
improving the design of the advertisement based on the score and the compared differences to create an improved advertisement, and to elevate consumer response to the improved advertisement.

9. One or more computer readable media as recited in claim 8, further comprising computer-executable instructions for presenting the improved design to a client, where the improved design is indicative of the objective factors used as a basis for the changes to the design.

10. One or more computer readable media as recited in claim 8, wherein the design is already in circulation and the additional design was created utilizing the design research data and the objective factors to develop a basis for comparison with the design already in circulation.

11. One or more computer readable media as recited in claim 8, wherein the design is already in circulation for use by a client and the additional design is a competing design to the client.

12. One or more computer readable media as recited in claim 8, wherein the design scoring methodology includes a scorecard that provides an objective summary of measurable scoring results of the design and the additional design, such that the scorecard indicates areas where the design and the additional design lack content that elevates consumer response.

13. A research-based design system, comprising:
research data and objective factors found to produce an elevated consumer response;
a design evaluation application configured to:
score the design to generate a score utilizing a scoring methodology based on the research data and objective factors;
score the additional design to generate an additional score based on the scoring methodology;
compare differences in the scores of the design and the additional design to support a basis for an improvement to the design; and
generate an improved design based on the research data, the compared differences in the scores of the design and the additional design, and the absence of content in the design that would produce the elevated consumer response.

14. The system as recited in claim 13, wherein the design is already in circulation by a client and the design was created utilizing the research data and the objective factors to develop a basis for comparison with the design already in circulation.

15. The system as recited in claim 13, wherein the design is already in circulation for use by a client and the additional design is a competing design of the client.

16. The system as recited in claim 13, wherein the design and the additional design are yellow pages advertisements and the research data is yellow pages-industry advertisement data that establishes the most appropriate directory, heading, and page position for the yellow pages advertisements, as well as the high traffic areas of the yellow pages text and the demographic profiles of potential customers of the advertisement and the additional advertisement.

17. The system as recited in claim 13, wherein the design evaluation application is further configured to generate the score and the improved design to a client, where the score is indicative of the objective factors used as a basis for the improved design.

18. The system as recited in claim 13, wherein the design evaluation application is further configured to track results of the elevated consumer response to the improved design by generating at least one of online questionnaires or focus group analysis results.

19. The system as recited in claim 13, wherein the design evaluation application is further configured to determine a success of the improved design, which is at least one of a product design or a service design, and wherein the success of the improved design is based on the research data and the objective factors that are relevant to the product or service.

20. The system as recited in claim 13, wherein the scoring methodology includes a scorecard that provides an objective summary of measurable scoring results of the design and the additional design, and wherein the scorecard indicates areas where the design and the additional design lack content that elevates consumer response.
